(19) United States
(12) Patent Application Publication
(10) Pub. No.: US 2009/0022851 A1
(43) Pub. Date: Jan. 22, 2009

(54) METHOD OF USING OLIGOMERIC POLYPHENOL COMPOUNDS AND BIOFLAVONOIDS TO ALTER BUBBLE SIZE OF SOFT DRINKS

(75) Inventors: Glenn Roy, Beacon, NY (US); Kevin Cortolano, Nanuet, NY (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: PEPSICO, INC., Purchase, NY (US)

(21) Appl. No.: 12/147,226

(22) Filed: Jun. 26, 2008

Related U.S. Application Data
(60) Provisional application No. 60/950,044, filed on Jul. 16, 2007.

(51) Int. Cl. A23L 2/40; A23L 2/56; A23L 2/58; A23L 2/00; A23L 2/54

(52) U.S. Cl. 426/67

(57) ABSTRACT

Non-alcoholic carbonated beverage compositions have been formulated to incorporate polyphenolic compounds, such as oligomeric polyphenolic compounds or bioflavonoids. Carbonated beverage compositions including polyphenolic compounds were discovered to exhibit the effervescence of small bubbles without the presence of carbonation produced via fermentation. Xanthan gum and juice are optionally included in the beverage compositions to provide a synergistic effect with the polyphenolic compound on the carbonation effervescence.

### CROSS REFERENCE TO RELATED APPLICATIONS

This application claims priority to provisional U.S. Application No. 60/950,044, filed Jul. 16, 2007, incorporated herein by reference in its entirety.

### FIELD OF THE INVENTION

This invention relates to beverages and beverage compositions. In particular, this invention relates to non-alcoholic carbonated beverage compositions having formulations incorporating polyphenolic compounds.

### BACKGROUND OF THE INVENTION

It has long been known to produce beverages of various formulations. Improved and new formulations are desirable to meet changing market demands. In particular, there is perceived market demand for beverages having pleasant taste, appearance, and mouthfeel. For example, the bubbles released from beverages such as carbonated non-alcoholic drinks (i.e., soft drinks) or sparkling wines may be considered appealing to consumers. Sparkling wines in general, and champagne in particular, typically effervesce bubbles that are smaller in size than the bubbles released from carbonated soft drinks.

Carbonation is the dissolution of carbon dioxide in an aqueous solution, such as a beverage. Soft drinks, for example, contain carbon dioxide that has been injected into the beverage under high pressure, producing carbonic acid in the soft drink. When the pressure is released, the equilibrium shifts and much of the carbonic acid is converted back to gaseous carbon dioxide. The carbon dioxide nucleates within the beverage, forming bubbles that effervesce and escape from the beverage. Nucleation is the beginning of a phase change, which may occur at a nucleation site, such as on the beverage container surface or on a particle or miniscule air bubble suspended in the beverage.

Carbonation can also be produced naturally by yeasts during fermentation. That is, fermentation of alcoholic beverages such as champagne can produce the effect of small bubbles in a beverage. Small bubbles provide a softer, less irritating feel in the mouth than the large bubbles produced in non-alcoholic drinks.

It is desirable to improve the appearance and taste properties of carbonated beverage compositions, including providing effervescence of smaller carbonation bubbles than previously achieved in non-alcoholic beverage compositions. Features and advantages of the invention or of certain embodiments of the invention will be apparent to those of skill in the art from the following disclosure and description of exemplary embodiments.

### SUMMARY OF THE INVENTION

In accordance with a first aspect, a non-alcoholic beverage composition comprises polyphenols, such as oligomeric polyphenol compounds or bioflavonoids, to alter the size of the bubbles of carbon dioxide released from the beverage. Certain exemplary embodiments of the beverage composition disclosed herein also comprise xanthan gum and/or juice to further alter the degassing characteristics of the beverages.

In accordance with another aspect, a method for preparing a non-alcoholic beverage composition comprises the steps of providing carbonated water and admixing the carbonated water with a polyphenolic compound. Certain exemplary embodiments of the method disclosed herein also comprise blending xanthan gum and/or juice into the beverage composition.

### DETAILED DESCRIPTION OF EMBODIMENTS OF THE INVENTION

It should be understood that beverages and beverage compositions in accordance with this disclosure may have any of numerous different specific formulations or constitutions. The formulation of a beverage composition may vary to a certain extent, depending upon such factors as the product's intended market segment, its desired nutritional characteristics, flavor profile and the like. For example, sweeteners, flavorings, vitamins, caffeine, preservatives, and/or coloring agents may be added to any of the formulations to vary the taste, mouthfeel, nutritional characteristics, etc. In general, a beverage in accordance with this disclosure typically comprises at least water, carbonation, and a polyphenolic compound. Additional and alternative suitable ingredients will be recognized by those skilled in the art given the benefit of this disclosure.

It has been discovered that the inclusion of various polyphenolic compounds in non-alcoholic beverage compositions results in the effervescence of small bubbles that are similar in size to the bubbles in champagne. Polyphenols include compounds having more than one phenol group on each molecule, and the compounds are often subdivided into tannins, bioflavonoids, and lignins. Tannins are large polyphenolic compounds having hydroxyl and carboxyl groups, and are capable of forming strong complexes with macromolecules, such as proteins. Foods that contain tannins include pomegranates, persimmons, cranberries, strawberries, blueberries, tea and wine. Bioflavonoids are secondary metabolite products synthesized by plants. Bioflavonoids may be extracted from edible plants, such as from red grapes, cherries, chokeberries, blackcurrant, oranges, grapefruit and eggplant. Oligomeric polyphenolic compounds (OPCs) are another kind of polyphenolic compound and may be obtained from plants. Pycnogenol OPC, for example, is an extract of French maritime pine bark. Specific substances that were each observed to produce small bubbles in soft drinks include chitosan, grapefruit extract, pycnogenol OPCs, tannic acid and grape seed extract. Without wishing to be bound by any particular theory, it is believed that the presence of the polyphenolic compound(s) alters the surface tension of the coalescing of bubbles, which allows the nucleation of smaller bubbles. In certain embodiments of the beverage compositions of the present invention, polyphenolic compounds may be employed at a concentration of from about 5 ppm to about 1000 ppm.

Water is a basic ingredient in the beverage compositions disclosed here, typically being the vehicle or primary liquid portion in which the remaining ingredients are dissolved, emulsified, suspended or dispersed. Purified water can be used in the manufacture of certain embodiments of the beverage compositions disclosed here, and water of a standard beverage quality can be employed in order not to adversely affect beverage taste, odor, or appearance. The water typically will be clear, colorless, free from objectionable minerals, tastes and odors, free from organic matter, low in alkalinity and of acceptable microbiological quality based on industry and government standards applicable at the time of producing the beverage. In certain typical embodiments, water is present at a level of from about 80% to about 99.9% by weight of the beverage composition. In at least certain exemplary embodiments the water used in beverages and concentrates disclosed here is “treated water,” which refers to water that has been treated to reduce the total dissolved solids of the water prior to optional supplementation, e.g., with calcium as disclosed in U.S. Pat. No. 7,052,725. Methods of producing treated water are known to those of ordinary skill in the art and include deionization, distillation, filtration and reverse osmosis (“r-o”), among others. The terms “treated water,” “purified water,”, “demineralized water,” “distilled water,” and “r-o water” are understood to be generally synonymous in this discussion, referring to water from which substantially all mineral content has been removed, typically containing no more than about 500 ppm total dissolved solids, e.g. 250 ppm total dissolved solids.

Carbon dioxide is used to provide effervescence to the beverage compositions disclosed herein. Any of the techniques and carbonating equipment known in the art for carbonating beverages can be employed. Carbon dioxide can enhance the beverage taste and appearance and can aid in safeguarding the beverage purity by inhibiting and destroying objectionable bacteria. In certain embodiments, for example, the beverage has a CO₂ level up to about 7.0 volumes carbon dioxide. Typical embodiments may have, for example, from about 0.5 to 5.0 volumes of carbon dioxide. As used here, one volume of carbon dioxide is defined as the amount of carbon dioxide absorbed by any given quantity of water at 60° F. (16° C.) and atmospheric pressure. A volume of gas occupies the same space as does the water by which it is absorbed. The carbon dioxide content can be selected by those skilled in the art based on the desired level of effervescence and the impact of the carbon dioxide on the taste or mouthfeel of the beverage.

Xanthan gum is a polysaccharide employed in comestibles for the purpose of increasing viscosity. Because xanthan gum is stable over a wide range of temperatures and pH conditions, it is commonly used. Xanthan gum may also improve the mouthfeel of a food or beverage. Xanthan gum may optionally be included in the beverage composition disclosed here and is believed to work synergistically with the polyphenolic compound to reduce the rate of degassing of the beverage. In certain embodiments of the beverage compositions of the present invention, xanthan gum may be employed at a concentration of from about 5 ppm to about 1000 ppm.

Juice may optionally be included in the beverage composition and is also believed to work synergistically with the polyphenolic compound to reduce the rate of degassing of the beverage. Additionally, the presence of juice may provide improved mouthfeel to the beverage. Juices suitable for use in at least certain exemplary embodiments of the beverage compositions disclosed here include, e.g., fruit, vegetable and berry juices. Juices can be employed in the present invention in the form of a concentrate, puree, single-strength juice, or other suitable forms. The term “juice” as used here includes single-strength fruit, berry, or vegetable juice, as well as concentrates, purees, milks, and other forms. Multiple different fruit, vegetable and/or berry juices can be combined, optionally along with other flavorings, to generate a beverage having the desired flavor. Examples of suitable juice sources include plum, prune, date, currant, fig, grape, raisin, cranberry, pineapple, peach, banana, apple, pear, guava, apricot, Saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, sloe, rowan, gooseberry, pomegranate, persimmon, mango, rhubarb, papaya, litchi, lemon, orange, lime, tangerine, mandarin and grapefruit etc. Numerous additional and alternative juices suitable for use in at least certain exemplary embodiments will be apparent to those skilled in the art given the benefit of this disclosure. In the beverage compositions of the present invention employing juice, juice may be used, for example, at a concentration of at least about 1 ppm. In certain exemplary embodiments juice is employed at a concentration of from about 5 ppm to about 4000 ppm.

### EXAMPLES

The following examples are specific embodiments of the present invention but are not intended to limit it.

A carbonated non-alcoholic base beverage composition was prepared according to the formulation of Table 1.

TABLE 1
Non-alcoholic base beverage composition

| Formula | lb/900 gal | |
|---|---|---|
| Sodium Chloride | 0.496 | |
| Citric Acid Anhydrous | 2.403 | |
| Malic Acid | 2.013 | |
| Grape Seed Extract | 0.376 | |
| Xanthan Gum, Keltrol R.D. | 0.901 | |
| Apple Flavor | 8.512 | |
| Clarified Goji Juice Conc (49 brix) | 24.336 | |
| Agave Nectar | 37.554 | |
| Sucrose Granulated | 713.517 | |
| Treated Water (to Yield) | 900 | gal |

Various compounds, in an amount of between about 5-60 mg, were added to 10-ounce samples of the non-alcoholic base composition. Next, the carbonation bubbles produced in each composition were observed both in a glass container and following pouring of the composition into a plastic container. The specific compounds and their effect on bubble generation with respect to the base control composition are shown in Table 2. The observations in Table 2 indicate that the presence of polyphenolic compound resulted in nucleation of small bubbles in the beverage compositions. In particular, the tannin polyphenol of tannic acid and the bioflavonoid polyphenols of grapefruit extract, pycnogenol OPC, and grape seed extract strongly affected the bubble size of the effervescence. Chitosan, a polysaccharide, showed the small nucleation of bubbles to a lesser extent than the polyphenolic compounds.

TABLE 2
Carbonation Bubble Modification Study
(n/e = no effect compared to control))

| | | Observation 1 | Observation 2 |
|---|---|---|---|
| | mg/ | (looking in | (over time |
| | 10 oz. | opened | when poured |
| Ingredient | glass | glass bottle) | into plastic cup) |
| Control | n/a | normal degassing | large coalescing |
| | | by large | bubbles stuck to cup |
| | | coalescing | sides and bottom |
| | | bubbles | |
| Chitosan | 17 | some smaller | some smaller |
| | | nucleation | nucleation |
| Carnitine (base) | 40 | n/e | n/e |
| Glucosamine HCl | 40 | n/e | n/e |
| Grapefruit Extract | 16 | rising bubbles of | small nucleation on |
| | | smaller nucleation | bottom; streaming |
| | | | upwards; looks |
| | | | almost non-carb |
| Collagen | 12 | n/e | n/e |
| Polyvinylpyrolidinone | 16 | n/e | n/e |
| Pycnogenol OPCs | 15 | streaming rising | small nucleation on |
| | | bubbles of | bottom; streaming |
| | | smaller nucleation | upwards; looks |
| | | | almost non-carb |
| Glutamine peptide | 17 | n/e | n/e |
| Betaine | 45 | n/e | n/e |
| Poly-lysine | 35 | n/e | n/e |
| Chondroitin sulfate | 43 | n/e | n/e |
| Choline bitartrate | 57 | n/e | n/e |
| Phosphatidyl serine as | 13 | n/e | n/e |
| soy lecithin | | | |
| Agaric acid | 7 | n/e | n/e |
| Tannic acid | 6 | rising bubbles of | smaller nucleation |
| | | smaller nucleation | on bottom; looks |
| | | | non-carb |
| Grape seed extract | 10 | rising bubbles of | smaller nucleation |
| | | smaller nucleation | on bottom; looks |
| | | | non-carb |
| L-histidine | 7 | n/e | n/e |

What is claimed is:

1. A non-alcoholic beverage composition comprising:
water;
carbon dioxide; and
a polyphenolic compound;
wherein the carbon dioxide is released from the beverage composition via bubbles substantially similar in size to bubbles effervesced by champagne.

2. The beverage composition of claim 1, wherein the polyphenolic compound is present in an amount of between about 5 ppm and 1000 ppm.

3. The beverage composition of claim 2, wherein the polyphenolic compound is an oligomeric polyphenol compound.

4. The beverage composition of claim 2, wherein the polyphenolic compound is a bioflavonoid.

5. The beverage composition of claim 1, further comprising xanthan gum.

6. The beverage composition of claim 5, wherein the xanthan gum is present in an amount of between about 5 ppm and 1000 ppm.

7. The beverage composition of claim 1, further comprising juice.

8. The beverage composition of claim 7, wherein the juice is present in an amount of between about 5 ppm and 4000 ppm.

9. A method for making a non-alcoholic beverage composition having small carbonation bubbles, comprising the steps of:
carbonating water; and
admixing the carbonated water with a polyphenolic compound.

10. The method of claim 9, wherein the polyphenolic compound is an oligomeric polyphenol compound.

11. The method of claim 9, wherein the polyphenolic compound is a bioflavonoid.

12. The method of claim 9, wherein the polyphenolic compound is present in an amount of between about 5 ppm and 1000 ppm.

13. The method of claim 9, further comprising the step of blending xanthan gum with the admixture.

14. The method of claim 9, further comprising the step of blending juice with the admixture.
